(19) United States
(12) Patent Application Publication
(10) Pub. No.: US 2026/0151974 A1
(43) Pub. Date: Jun. 4, 2026

(54) REPLICATION TOOL FOR PRODUCING A PLURALITY OF OPTICAL ELEMENTS, AND METHOD FOR PRODUCING A PLURALITY OF OPTICAL ELEMENTS

(71) Applicant: HEPTAGON PHOTONICS PTE. LTD., Singapore (SG)

(72) Inventors: Davide GROSSI, Bern (CH); Paul COMMIN, Zurich (CH); Nicola SPRING, Oberterzen (CH)

(21) Appl. No.: 19/457,326

(22) Filed: Jan. 23, 2026

Related U.S. Application Data
(63) Continuation of application No. PCT/EP2024/066566, filed on Jun. 14, 2024.

(30) Foreign Application Priority Data
Jul. 26, 2023 (DE) 10 2023 119 837.8

(51) Int. Cl. B29D 11/00; B29K 63/00

(52) U.S. Cl. CPC B29D 11/0048; B29D 11/00365; B29K 2063/00

(57) ABSTRACT

A replication tool for producing, from a replication material, a plurality of optical elements, the replication tool extending in a horizontal direction, may comprise a first main surface, and a replication surface being opposite to the first main surface and configured to be in contact with the replication material, the replication surface comprising a plurality of replication sections, each of the replication sections being configured to shape a corresponding one of the optical elements, and each of the replication sections comprising a protruding portion, which is configured to define a concave surface of the optical element, and a peripheral portion, the peripheral portion surrounding the protruding portion and comprising a downward slope extending outwards from an outer boundary of the protruding portion and in a downward direction, the downward direction being perpendicular to the horizontal direction and extending away from the first main surface of the replication tool.

### BACKGROUND

A plurality of optical elements can be manufactured by replicating a 3D-structure from epoxy or other liquid precursors. A replication tool can include a plurality of replication sections, each of the replication sections being configured to shape a corresponding one of the optical elements.

Generally, concepts are being sought which allow to minimize an overlap of adjacent optical elements in the plurality of optical elements manufactured by replication.

It is an object of the present invention to provide an improved replication tool for producing a plurality of optical elements, an improved method for producing a plurality of optical elements, and an improved plurality of optical elements.

### SUMMARY

According to embodiments, the above object is achieved by the claimed matter according to the independent claims. Further developments are defined in the dependent claims.

According to embodiments, a replication tool for producing, from a replication material, a plurality of optical elements, extends in a horizontal direction. The replication tool comprises a first main surface, and a replication surface being opposite to the first main surface and configured to be in contact with the replication material. The replication surface comprises a plurality of replication sections, each of the replication sections being configured to shape a corresponding one of the optical elements. Each of the replication sections comprises a protruding portion, which is configured to define a concave surface of the optical element, and a peripheral portion, the peripheral portion surrounding the protruding portion and comprising a downward slope extending outwards from an outer boundary of the protruding portion and in a downward direction. The downward direction is perpendicular to the horizontal direction and extends away from the first main surface of the replication tool.

The peripheral portion may further comprise a necking feature, the necking feature being adjacent to the downward slope and extending in the horizontal direction from the downward slope away from the protruding portion.

According to embodiments, the peripheral portion may further comprise an upward slope adjacent to the necking feature, the upward slope extending outwards from the necking feature and in the upward direction, the upward direction being opposite to the downward direction.

The peripheral portion may further comprise a plateau feature adjacent to the upward slope and extending from the upward slope outwards and in the horizontal direction.

The plateau features of adjacent replication sections may overlap.

According to embodiments, the replication tool may further comprise a spacer feature between the outer boundary of the protruding portion and the downward slope, the spacer feature extending in the horizontal direction.

According to embodiments, the optical elements defined by the replication tool may be high sag concave lenses.

According to embodiments, a method for producing a plurality of optical elements comprises disposing a replication material between a replication tool and a substrate, the replication tool comprising a first main surface, and a replication surface being opposite to the first main surface and configured to be in contact with the replication material. The replication surface comprises a plurality of replication sections, each of the replication sections being configured to shape a corresponding one of the optical elements.

Each of the replication sections comprises a protruding portion, which is configured to define a concave surface of the optical element, and a peripheral portion, the peripheral portion surrounding the protruding portion and comprising a downward slope extending outwards from an outer boundary of the protruding portion and in a downward direction, the downward direction being perpendicular to the horizontal direction and extending away from the first main surface of the replication tool.

According to embodiments, the method further comprises moving the replication tool and/or the substrate towards each other so that the replication material is in contact with both the replication tool and the substrate and hardening the replication material.

According to embodiments, the replication material is disposed at least in a cavity of the replication surface of the replication tool, the cavity being formed between the protruding portion and the downward slope.

The peripheral portion may further comprise a necking feature, the necking feature being adjacent to the downward slope and extending in the horizontal direction. The replication tool and/or the substrate may be moved towards each other so that a portion of the replication material is confined between the necking feature and the substrate by means of capillary forces and/or surface tension.

The peripheral portion may further comprise an upward slope adjacent to the necking feature, the upward slope extending outwards from the necking feature and in the upward direction, the upward direction being opposite to the downward direction. The replication tool and/or the substrate may be moved towards each other so that the flow of the replication material is stopped at the upward slope by means of capillary forces and/or surface tension.

The peripheral portion may further comprise a plateau feature adjacent to the upward slope and extending from the upward slope outwards and in the horizontal direction. A volume between the plateau feature and the substrate may define an overflow volume, which can be at least partially filled by the replication material, and which can separate two adjacent optical elements from each other.

According to embodiments, the plateau features of adjacent replication sections may overlap.

According to embodiments, the method further comprises separating the plurality of optical elements into single optical elements or groups of optical elements.

According to embodiments, an optical element is obtained by the method described above.

### BRIEF DESCRIPTION OF FIGURES

The accompanying drawings are included to provide a further understanding of embodiments of the invention and are incorporated in and constitute a part of this specification. The drawings illustrate the embodiments of the present invention and together with the description serve to explain the principles. Other embodiments of the invention and many of the intended advantages will be readily appreciated, as they become better understood by reference to the following detailed description. The elements of the drawings are not necessarily to scale relative to each other. Like reference numbers designate corresponding similar parts.

FIG. 1A is a schematic cross-sectional view of a replication tool for producing a plurality of optical elements according to embodiments.

FIG. 1B is a schematic top view of replication tool from FIG. 1A.

FIG. 2 is a schematic cross-sectional view of a portion of a replication tool corresponding to one of the optical elements during a process of dispensing of the replication material according to embodiments.

FIG. 3 is a schematic cross-sectional view of a portion of a replication tool corresponding to one of the optical elements and the corresponding portion of replication material according to embodiments.

FIG. 4 is a schematic cross-sectional view of a portion of a replication tool corresponding to two adjacent optical elements and the corresponding portions of replication material according to embodiments, where the replication tool does not include downward slopes.

FIG. 5 is a schematic cross-sectional view of a portion of a replication tool corresponding to two adjacent optical elements and the corresponding portions of replication material according to embodiments, wherein the replication tool includes downward slopes.

FIG. 6 is a schematic top view of a plurality of optical elements according to embodiments.

FIG. 7 outlines a method according to embodiments.

### DETAILED DESCRIPTION

In the following detailed description reference is made to the accompanying drawings, which form a part hereof and in which are illustrated by way of illustration specific embodiments in which the invention may be practiced. In this regard, directional terminology such as “top”, “bottom”, “front”, “back”, “over”, “on”, “above”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments.

The term “vertical” as used in this specification intends to describe an orientation which is arranged perpendicular to the first surface of a substrate or semiconductor body.

The terms “lateral” and “horizontal” as used in this specification intends to describe an orientation parallel to a first surface of a substrate or semiconductor body. This can be for instance the surface of a wafer or a die.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

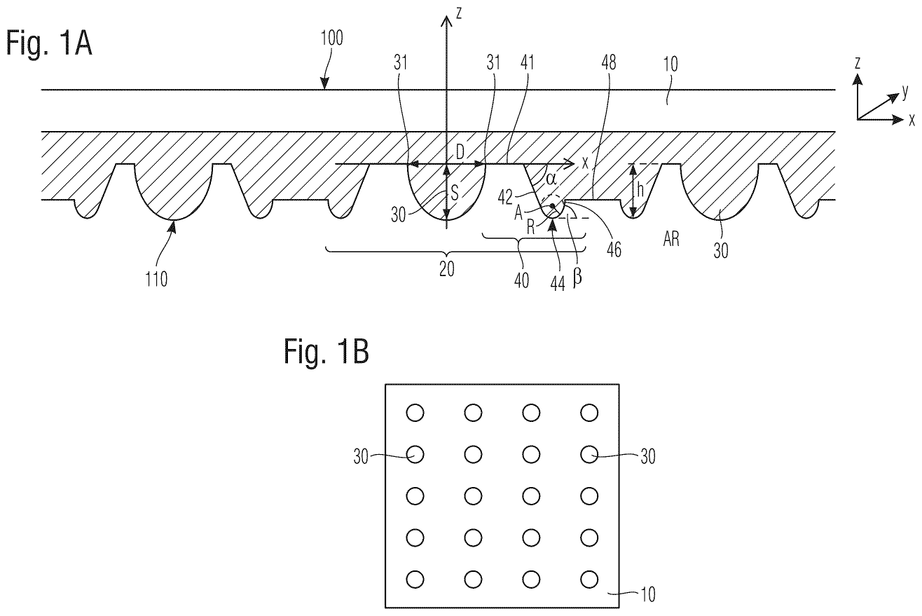

FIG. 1A is a schematic cross-sectional view of a replication tool 10 for producing a plurality of optical elements (not shown) from a replication material (not shown) according to embodiments. The replication tool 10 may extend in the horizontal direction. The replication tool may comprise a first main surface 100, and a replication surface 110 being opposite to the first main surface 100 and configured to be in contact with the replication material. According to the embodiment shown in FIG. 1A, the first may surface may be flat or planar.

The replication surface 110 may comprise a plurality of replication sections 20, each of the replication sections 20 being configured to shape a corresponding one of the optical elements. According to the embodiment shown in FIG. 1A, each of the plurality of replication sections 20 may have a rotational symmetry around a vertical axis, e.g., the z axis.

Each of the replication sections may comprise a protruding portion 30, which is configured to define a concave surface of the optical element, and a peripheral portion 40. The peripheral portion 40 surrounds the protruding portion 30. According to the embodiment shown in FIG. 1A, the cross-section of the protruding portion 30 is defined by a convex curve exhibiting a reflection symmetry around the vertical axis z.

The peripheral portion 40 may comprise a downward slope 42 extending outwards from an outer boundary 31 of the protruding portion 30 and in a downward direction. The downward direction is perpendicular to the horizontal direction and extends away from the first main surface 100 of the replication tool 10. According to the embodiment shown in FIG. 1A, the cross-section of the downward slope 42 is defined by a straight line inclined downwards. An inclination angle α between a horizontal axis x and the downward slope 42 may be greater than 40°. The angle α may be smaller than 90°or smaller than 80°. For example, the angle α may be smaller than 60°.

According to embodiments shown in FIG. 1A, the replication tool 10 may further comprise a spacer feature 41 between the outer boundary 31 of the protruding portion 30 and the downward slope 42, the spacer feature 41 extending in the horizontal direction. According to the embodiment shown in FIG. 1A, the cross-section of the spacer feature 41 is defined by a straight horizontal line. However, the spacer feature 41 may have a different shape, for example, the spacer feature 41 may be rounded.

As shown in FIG. 1A, the peripheral portion 40 may further comprise a necking feature 44, the necking feature 44 being adjacent to the downward slope 42 and extending in the horizontal direction from the downward slope 42 away from the protruding portion 30. According to the embodiment shown in FIG. 1A, the cross-section of the necking feature 44 may be defined by a rounded line. The necking feature 44 refers to a further protruding portion which has a smaller lateral extension, e.g. in a x- or y- or radial direction facing outward from the protruding portion 30. Accordingly, a curvature of the necking feature 44 is larger than the curvature of the protruding portion 30. For example, a radius R of curvature of the necking feature 44 may be less than 0.1 μm, e.g. less than 0.05 μm. The radius R of curvature may be larger than 0.01 μm. The radius of curvature may refer to a radius of a tangent circle adjacent to the necking feature 44 around a position A. For example, the tangent circle may be drawn at a position having a maximum distance to the first main surface 100. For example, a height h of the necking feature 44 measured in the vertical direction may be larger than 10 μm. For example, the height h of the necking feature 44 may be less than 50 μm. For example, as is shown in FIG. 1A, the height h of the necking feature may be smaller or equal to the height or sagitta S of the protruding portion 30. According to further embodiments, the height of the necking feature may be larger than the sagitta S of the protruding portion 30. The necking feature 44 may be configured to define a constriction between the replication tool 10 and the substrate (not shown), as will be described below.

As shown in FIG. 1A, the peripheral portion 40 may further comprise an upward slope 46 adjacent to the necking feature 44, the upward slope 46 extending outwards (i.e. in the direction away from the protruding portion 30) from the necking feature 44 and in the upward direction, the upward direction being opposite to the downward direction. According to the embodiment shown in FIG. 1A, the cross-section of the upward slope 42 is defined by a straight line inclined upwards. An inclination angle β between the horizontal axis x and the upward slope 46 may be greater than 50°. The angle β may be smaller than 60°. The inclination angle β between the horizontal axis x and the upward slope 46 is larger than 0°.

As can be seen from FIG. 1A, the peripheral portion 40 may further comprise a plateau feature 48 adjacent to the upward slope 46 and extending from the upward slope 46 outwards and in the horizontal direction. According to the embodiment shown in FIG. 1A, the cross-section of the plateau feature 48 is defined by a straight horizontal line.

The plateau features 48 of adjacent replication sections 20 may overlap, as shown in FIG. 1A. In other words, the plateau features 48 of adjacent replication sections 20 may merge into one another.

According to embodiments, the optical elements defined by the replication tool may be high sag (sagitta) concave lenses. As shown in FIG. 1A, a diameter D of the optical element defined by the protruding portion 30 of the replication section 20 is equal to a diameter D of the protruding portion 30, the diameter D of the protruding portion 30 being a distance between opposing points of the outer boundary 31 of the protruding portion 30. A sagitta (sag) S of the optical element is equal to a sagitta (sag) S of the protruding portion 30, the sagitta S of the protruding portion 30 being defined by a vertical depth of the protruding portion 30. For high sag concave lenses defined by the replication section 20, the ratio S/D of the sagitta S and the diameter D can be more than 0.1. For example, the ratio S/D may be less than 0.6 or less than 0.5. For example, the sagitta S may be greater than 10 μm. The sagitta S may be smaller than 70 μm.

FIG. 1B is a schematic top view of replication tool 10 shown in FIG. 1A from the side of the replication surface 110. FIG. 1B specifically shows the protruding portions 30, which may be arranged in a rectangular array.

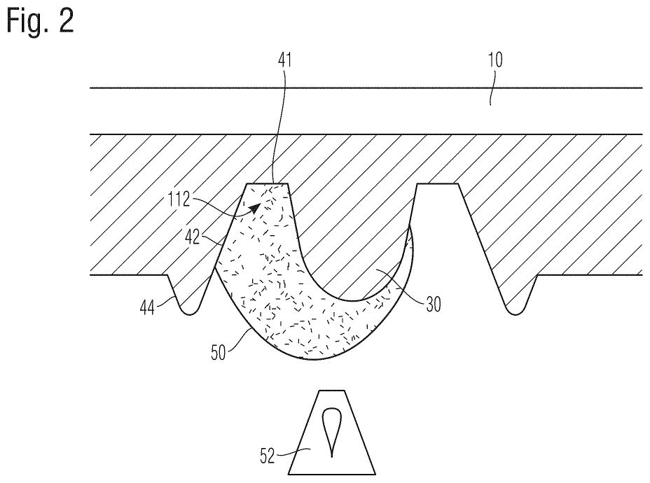

FIG. 2 is a schematic cross-sectional view of a portion of the replication tool 10 corresponding to one of the optical elements during a first process of a method for producing a plurality of optical elements, according to embodiments. As the first process, a replication material 50 is disposed between the replication tool 10 and a substrate (not shown). According to the embodiment shown in FIG. 2, replication material 50 may be dispensed by a dispenser 52 at the replication surface 110 of the replication tool 10. The replication material 50 may be epoxy or other liquid precursor, which may be hardened in a later process step.

As shown in FIG. 2, a portion of the replication material 50 is disposed at least in a cavity 112 of the replication surface 110 formed between the protruding portion 30 and the downward slope 42. According to embodiments shown in FIG. 2, the cavity 112 is formed by the protruding portion 30, the downward slope 42 and the spacer feature 41.

As can be seen from FIG. 2, the presence of the downward slope 42, which represents a side wall of the cavity 112, has an effect that a flow of the replication material 50 is stopped, so that the position of the replication material 50 is stabilized due to capillary and/or surface tension forces. As a result, the replication material 50 remains at a place corresponding to the optical element to be produced. This effect is particularly pronounced in the case of producing high sag concave lenses, where the curvature of the protruding portion 30 of the replication tool 10 is high. In this case it is possible that the replication material 50 is not stable in the position where it is dispensed, but can move to the side of the protruding portion 30, increasing the risk of overflow of the replication material 50 from the intended position.

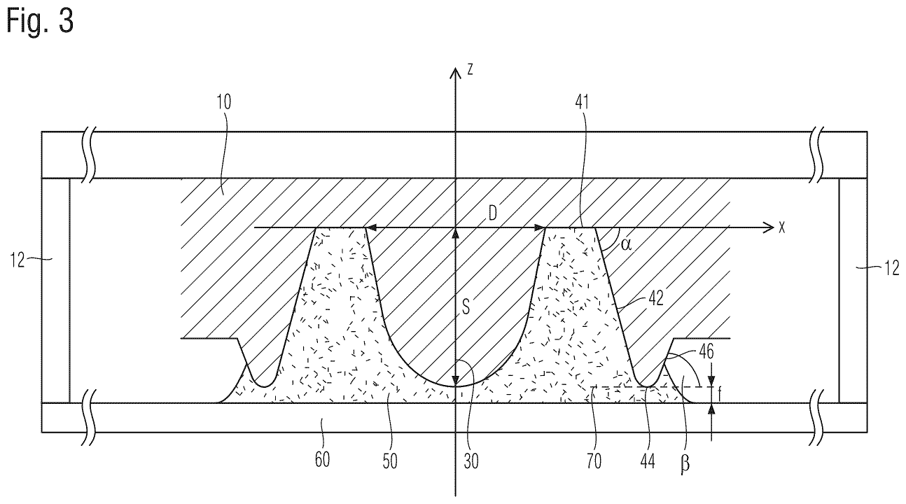

FIG. 3 is a schematic cross-sectional view of the replication section 20 corresponding to one of the plurality of optical elements and the corresponding portion of replication material 50, according to embodiments, after a subsequent process of the method, at which the replication tool 10 and/or a substrate 60 are moved towards each other. The vertical distance between the replication tool 10 and the substrate 60 may be controlled by means of vertical spacer features 12 of the replication tool 10, so that the relative movement of the replication tool 10 and the substrate 60 towards each other stops, when the vertical spacer features 12 get in contact with the substrate 60. The vertical spacer features 12 may be positioned, e.g., at the outer periphery of the replication tool 10.

As can be seen from FIG. 3, after the above-mentioned moving process, the replication material 50 is in contact with both the replication tool 10 and the substrate 60, so that the replication material 50 is shaped by means of the replication tool 10 and the substrate 60. As a result, the replication material 50 takes on the form of an optical element 70 to be produced.

For example, a horizontal width of the necking feature 44 may be of the order of magnitude of 10 mm, e.g. smaller than 25 mm. For example, a vertical distance between the substrate 60 and the necking feature 44 may be greater than 10 mm after the moving process. Further, the vertical distance between the substrate 60 and the necking feature 44 may be smaller than 50 mm after the moving process.

According to embodiments, the method may further comprise hardening of the replication material 50. The replication material 50 may be epoxy and may be hardened by means of curing, e.g., UV-curing. The replication material 50 may include other liquid precursor, e.g., a curable polymer material like silicon, acrylate or the like, which can be hardened, e.g., by means of cross-linking of polymer chains.

According to embodiments, the method may further comprise removing the replication tool after the replication material is hardened. According to embodiments, the method may further comprise separating plurality of optical elements from the substrate.

As the replication material 50 is pressed between the replication tool 10 and the substrate 60, its flow is controlled by the features of the peripheral portion 40 described above, namely the downward slope 42, the necking feature 44, the upward slope 46 and the plateau feature 48.

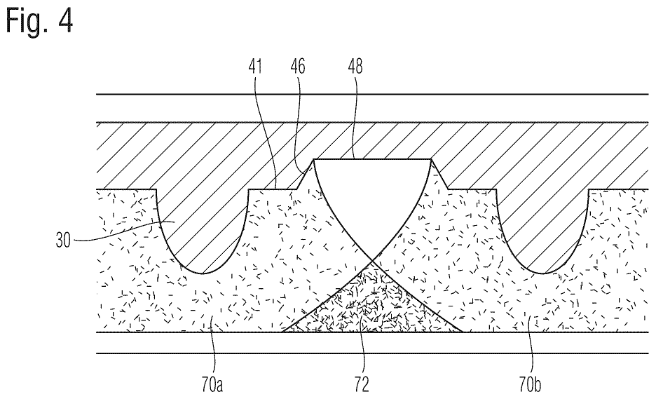

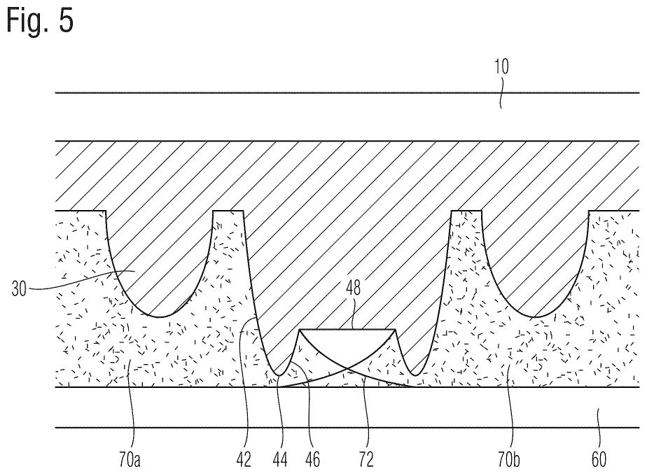

The control of the flow of the replication material 50 by means of the above-described features of the peripheral portion 40 of the replication tool 10 is explained in the following while referring to FIGS. 4 and 5. FIG. 4 is a schematic cross-sectional view of a portion of a replication tool 10 corresponding to two adjacent optical elements 70a and 70b, and the corresponding portions of replication material 50 according to an illustrative example. According to the illustrative example shown in FIG. 4, the replication tool 10 does not include the downward slope 42 and the necking feature 44.

FIG. 5 is a schematic cross-sectional view of a portion of a replication tool 10 corresponding to two adjacent optical elements 70a, 70b, and the corresponding portions of replication material 50, according to embodiments, wherein the replication tool includes the downward slope 42 and the necking feature 44.

As shown in FIG. 4, the replication material 50 is displaced by the replication tool 10 after the replication tool 10 and the substrate 60 are moved towards each other. The flow of the replication material 50 is stopped at the upward slope 46. Especially in the case of high sag concave lenses 70a, 70b, where large portions of the replication material 50 are displaced by the protruding portion 30 of the replication tool 10, this can lead to a substantial overlap 72 between the neighboring lenses 70a, 70b.

By contrast, as shown in FIG. 5, the presence of the downward slope 42 and of the necking feature 44 reduces the mutual overlap 72 and the influence of neighboring optical elements 70a, 70b on each other.

In other words, as shown in FIG. 5, the downward slope 42 allows to stabilize the position of the replication material 50 at the place, where the optical elements 70a, 70b are to be formed. The necking feature 44 decouples the optical elements 70a, 70b from each other, so that a portion of the replication material 50 is confined between the necking feature 44 and the substrate 60 by means of capillary forces and/or surface tension leaving only a thin layer of the replication material 50 as a connection between the neighboring elements 70a, 70b.

Furthermore, the flow of a portion of the replication material 50, which may escape through the necking feature 44, may be stopped at the upward slope 46 by means of capillary forces and/or surface tension. Moreover, a volume between the plateau feature 48 and the substrate 60 may define an overflow volume, which can be at least partially filled by the replication material 50, and which can separate two adjacent optical elements 70a, 70b from each other.

As shown above, the replication process for high sag concave lenses can be made more stable by using the replication tool 10 as described above, which allows reducing the overlap 72 between neighboring optical elements 70a, 70b.

According to embodiments, a plurality of optical elements 70 is obtainable by the method described above.

According to embodiments, the method may further comprise separating the plurality of optical elements into single optical elements or groups of optical elements.

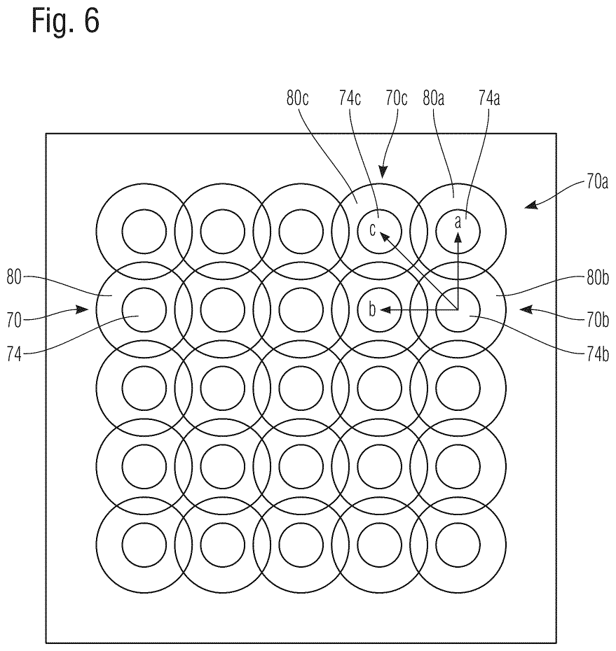

FIG. 6 is a schematic top view of a plurality of optical elements 70 obtained by the method described above, according to embodiments. As can be seen from FIG. 6, the optical elements 70 include a concave lens 74, which is defined by the protruding portion 30 of the replication tool 10 (as illustrated in FIG. 3) and a surrounding structure 80, which is defined by the peripheral portion 40 of the replication tool 10. As shown in FIG. 6, the surrounding structures 80a, 80b of neighboring optical elements 70a, 70b may overlap. However, since the overlap 72 between neighboring optical elements 70a, 70b can be reduced, as discussed above, the overlap of the surrounding structures 80a, 80b does not affect the optical performance of the optical elements 70. As a result, they can be packed closer together. This allows a reduction of a footprint of the plurality of optical elements 70 and therefore also a reduction of production costs.

In the case of a periodic rectangular array of optical elements 70 shown in FIG. 6, there is an asymmetry between a direction a or b towards the sides of the rectangles defining the array, and a diagonal direction c, so that a distance between optical elements 70a, 70b adjacent in the direction a or b is smaller than the distance between optical elements 70a, 70c adjacent in the diagonal direction c. Therefore, without decoupling the neighboring optical elements 70a, 70b and 70c from each other, the structure of the optical elements 70a, 70b and 70c would not be symmetric with respect to the rotation in the horizontal plane shown in FIG. 6. Therefore, the structure of the replication tool 10 described above, which allows reducing the overlap 72 between neighboring optical elements 70a, 70b and 70c, allows for more symmetric, more robust and more compact designs of the plurality of the optical elements 70.

The optical elements 70 produced using the replication tool 10 described herein may be used for illumination, for imaging elements, microcameras, projection devices, the production of structured light and further applications.

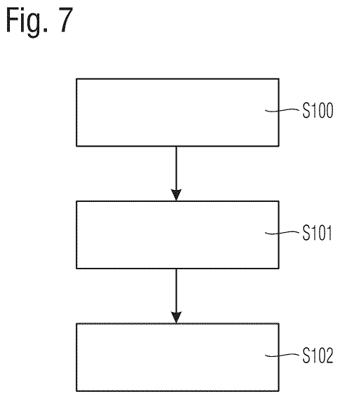

FIG. 7 outlines a method according to embodiments. A method for producing a plurality of optical elements comprises disposing (S100) the replication material 50 between the replication tool 10 and the substrate 60.

As shown in FIG. 7, the method further comprises moving (S101) the replication tool 10 and/or the substrate 60 towards each other so that the replication material 50 is in contact with both the replication tool 10 and the substrate 60.

Further, as shown in FIG. 7, the method comprises hardening (S102) the replication material.

While embodiments of the invention have been described above, it is obvious that further embodiments may be implemented. For example, further embodiments may comprise any subcombination of features recited in the claims or any subcombination of elements described in the examples given above. Accordingly, this spirit and scope of the appended claims should not be limited to the description of the embodiments contained herein.

### LIST OF REFERENCES

10 replication tool
12 vertical spacer feature
20 replication section
30 protruding portion
31 outer boundary of the protruding portion
40 peripheral portion
41 spacer feature
42 downward slope
44 necking feature
46 upward slope
48 plateau feature
50 replication material
52 dispenser
60 substrate
70, 70a, 70b, 70c optical element
72 overlap
74 lens
80 surrounding structure
100 first main surface
110 replication surface
112 cavity

What is claimed is:

1. A replication tool for producing, from a replication material, a plurality of optical elements, the replication tool extending in a horizontal direction, the replication tool comprising:
a first main surface, and
a replication surface being opposite to the first main surface and configured to be in contact with the replication material, the replication surface comprising a plurality of replication sections, each of the replication sections being configured to shape a corresponding one of the optical elements, and each of the replication sections comprising:
a protruding portion, which is configured to define a concave surface of the optical element, and
a peripheral portion, the peripheral portion surrounding the protruding portion and comprising a downward slope extending outwards from an outer boundary of the protruding portion and in a downward direction, the downward direction being perpendicular to the horizontal direction and extending away from the first main surface of the replication tool.

2. The replication tool according to claim 1, wherein the peripheral portion further comprises a necking feature, the necking feature being adjacent to the downward slope and extending in the horizontal direction from the downward slope away from the protruding portion.

3. The replication tool according to claim 2, wherein the peripheral portion further comprises an upward slope adjacent to the necking feature, the upward slope extending outwards from the necking feature and in the upward direction, the upward direction being opposite to the downward direction.

4. The replication tool according to claim 3, wherein the peripheral portion further comprises a plateau feature adjacent to the upward slope and extending from the upward slope outwards and in the horizontal direction.

5. The replication tool according to claim 4, wherein the plateau features of adjacent replication sections overlap.

6. The replication tool according to claim 1, further comprising a spacer feature between the outer boundary of the protruding portion and the downward slope, the spacer feature extending in the horizontal direction.

7. The replication tool according to claim 1, wherein the optical elements defined by the replication tool are high sag concave lenses.

8. A method for producing a plurality of optical elements, the method comprising:
disposing a replication material between a replication tool and a substrate, the replication tool comprising:
a first main surface, and
a replication surface being opposite to the first main surface and configured to be in contact with the replication material, the replication surface comprising a plurality of replication sections, each of the replication sections being configured to shape a corresponding one of the optical elements, and each of the replication sections comprising:
a protruding portion, which is configured to define a concave surface of the optical element, and
a peripheral portion, the peripheral portion surrounding the protruding portion and comprising a downward slope extending outwards from an outer boundary of the protruding portion and in a downward direction, the downward direction being perpendicular to the horizontal direction and extending away from the first main surface of the replication tool,
moving the replication tool and/or the substrate towards each other so that the replication material is in contact with both the replication tool and the substrate, and
hardening the replication material.

9. The method for producing a plurality of optical elements according to claim 8, wherein the replication material is disposed at least in a cavity of the replication surface of the replication tool, the cavity being formed between the protruding portion and the downward slope.

10. The method for producing a plurality of optical elements according to claim 8, wherein:
the peripheral portion further comprises a necking feature, the necking feature being adjacent to the downward slope and extending in the horizontal direction, and
the replication tool and/or the substrate are moved towards each other so that a portion of the replication material is confined between the necking feature and the substrate by means of capillary forces and/or surface tension.

11. The method for producing a plurality of optical elements according to claim 8, wherein:
the peripheral portion further comprises an upward slope adjacent to the necking feature, the upward slope extending outwards from the necking feature and in the upward direction, the upward direction being opposite to the downward direction, and
the replication tool and/or the substrate are moved towards each other so that the flow of the replication material is stopped at the upward slope by means of capillary forces and/or surface tension.

12. The method for producing a plurality of optical elements according to claim 8, wherein:
the peripheral portion further comprises a plateau feature adjacent to the upward slope and extending from the upward slope outwards and in the horizontal direction, and
a volume between the plateau feature and the substrate defines an overflow volume, which is at least partially filled by the replication material, and which separates two adjacent optical elements from each other.

13. The method for producing a plurality of optical elements according to claim 12, wherein
the plateau features of adjacent replication sections overlap.

14. The method for producing a plurality of optical elements according to claim 8, the method further comprising:
separating the plurality of optical elements into single optical elements or groups of optical elements.

15. An optical element obtainable by the method according to claim 8.
